(19) United States
(12) Patent Application Publication
(10) Pub. No.: US 2008/0011951 A1
(43) Pub. Date: Jan. 17, 2008

(54) HEAT IMAGING SENSOR FOR REAL-TIME CLOSED-LOOP CONTROL

(76) Inventors: Ray C. Delcher, Oxnard, CA (US); Mohsen Khoshnevisan, Newberry Park, CA (US); Bing Wen, Camarillo, CA (US)

Correspondence Address: ROCKWELL AUTOMATION, INC./BF, ATTENTION: SUSAN M. DONAHUE, E-7F19, 1201 SOUTH SECOND STREET, MILWAUKEE, WI, 53204, US

(21) Appl. No.: 11/672,407

(22) Filed: Feb. 7, 2007

Related U.S. Application Data
(60) Provisional application No. 60/766,710, filed on Feb. 7, 2006.

(51) Int. Cl. G01J 5/30

(52) U.S. Cl. 250/339.03; 250/339.04

(57) ABSTRACT

A real-time timing correction system for high speed control of hot glue dispensing uses a thermal-infrared detector and a feedback control loop distinguishing dispensed hot glue from a substrate by heat emissions.

### CROSS REFERENCE TO RELATED APPLICATION

This application claims the benefit of the U.S. provisional application 60/766,710 entitled: “Hot Glue And Thermal Web Sensor For Inspection And Control Of High-Speed Processes” filed on Feb. 7, 2006 and hereby incorporated by reference.

### STATEMENT REGARDING FEDERALLY SPONSORED RESEARCH OR DEVELOPMENT

--

### BACKGROUND OF THE INVENTION

The present invention relates to systems for the real-time control of hot glue dispensing equipment and in particular to a closed-loop control system employing a thermal-infrared sensor for detecting variation in glue times.

Hot glue dispensed from a hot glue gun may be used for the rapid automated assembly of products, for example, cardboard boxes, the latter which have joints held together with hot glue. Unlike conventional adhesives, hot glue provides fast setting times without the need for dangerous solvents or the mixing of multiple part formulations. The glue, when heated, may be dispensed in a tacky state under pressure through a nozzle. When the glue cools, a strong bond is created.

Precise timing of the dispensing of hot glue is extremely important in a high-speed assembly line. Delays or advances in the dispensing time, as products move by the glue gun, can leave beads or strings of glue extending from the seams or create seams that are improperly or incompletely glued and hence sealed. The dispensing of hot glue at times when the product is not properly aligned with the glue gun can dispense glue on the conveyor system creating costly downtime for high-speed assembly machines.

Repeatable and precise and high-speed operation of the valving mechanism of a hot glue gun is difficult. The speed at which the valve opens and closes is highly dependent on variations in the glue batch and temperature and can shift as the valve operates. The intrinsic variations in the response time of the valve place significant limits on the throughput of assembly machines using hot glue dispensers.

One solution to variations in hot glue gun response times is to observe the dispensed glue beads and from this observation, correct the trigger signal provided to the glue gun valve to compensate for any timing errors. Unfortunately imaging of the glue beads at high speed is difficult because the glue is transparent or light in color and often dispensed on a light surface, for example, light paper stock. One solution is to dye the glue, for example, with fluorescent dye normally invisible to the consumer. This approach is not always practical for reasons of consumer acceptance or expense.

It is also known to image hot glue beads using thermal-infrared sensors that can distinguish hot glue from the substrate on the basis of temperature. Practical thermal-infrared imagers are either relatively sluggish in performance, noisy, or require expensive and unreliable cryogenic cooling, and thus have not been used for real-time, closed-loop control but only for quality assessment purposes where the errors are analyzed off line and used to schedule maintenance for adjustment of the glue gun.

### SUMMARY OF THE INVENTION

The present invention provides closed-loop control of a glue gun using thermal-infrared sensing. Key to this breakthrough is the development of a practical high-speed thermal-infrared sensor providing improved signal to noise ratio and reduced threshold drift.

Specifically, the present invention provides a system including a hot glue gun receiving a trigger signal at a trigger time to actuate a dispensing of glue on a substrate at a dispensing time. A thermal-infrared sensor views a pattern of dispensed glue on the substrate by detecting a temperature difference between the substrate and the glue to produce a detection signal and a comparison circuit receives the detection signal to detect an error caused by variations between the trigger time and a dispensing time. A modification circuit modifies the trigger signal based on this error to reduce the detected error.

Thus it is one feature of at least one embodiment of the invention to provide for real-time correction of the operation of a hot glue gun at commercially practical assembly line speeds.

The system may include a transport mechanism moving the substrate with respect to the hot glue dispenser and the thermal-infrared sensor, the transport mechanism providing a displacement output, and the comparison circuit may receive the displacement output and detect error by comparing the displacement output at a time of the detection signal to a known displacement output at the trigger time modified by an offset in displacement between the hot glue dispenser and the thermal-infrared sensor.

Alternatively, the comparison circuit may detect error by comparing a time of the detection signal to the trigger time modified by an offset in time between alignment of the substrate with the hot glue gun and the thermal-infrared sensor.

Thus it is an feature of at least one embodiment of the invention to permit displacement of the thermal-infrared sensor from the glue gun for practical manufacturing, using either an encoder on a conveyor belt or the like, or knowledge of the time delay between dispensing and detection.

The thermal-infrared sensor may be a photoconductive thermal-infrared sensor.

Thus it is a feature of at least one embodiment of the invention to provide a detector providing improved response time over photo-resistive detectors

The thermal-infrared sensor may be a PbSe thermal-infrared sensor.

It is thus one feature of at least one embodiment of the invention to provide for a commercially practical thermal-infrared sensor.

The thermal-infrared sensor may have an aspect ratio of greater than three to one and the long dimension of the thermal-infrared sensor may be positioned to image perpendicularly to the motion of the substrate.

It is thus another feature of at least one embodiment of the invention to accommodate conveyor belt lateral shifting while minimizing the acceptance of detector noise, which in a thermal-IR detector increases with detector area.

The thermal-infrared sensor may be operated with a constant voltage bias.

It is thus another feature of at least one embodiment of the invention to manage the voltage drift of available thermal-infrared sensors.

The thermal-infrared sensor may be mounted to a temperature-controlled substrate.

It is another feature of at least one embodiment of the invention to reduce temperature drift of the sensor for practical use in an industrial environment.

The thermal-infrared sensor may include a filter optically blocking light above and below a 3.5-μm wavelength.

It is thus another feature of at least one embodiment of the invention to minimize lighting interference necessarily a part of an industrial environment.

The thermal-infrared sensor may be positioned behind a window of halogenated plastic.

It is thus another feature of at least one embodiment of the invention to provide a practical, rugged, and low absorption protection of the sensor in the industrial environment.

The thermal-infrared sensor may receive an image of the substrate projected by reflective optics on the sensor. The thermal-infrared sensor may be offset from a path of light from the substrate to the reflective optics.

It is thus another feature of at least one embodiment of the invention to provide improved detector sensitivity without the need for expensive optical materials.

The thermal-infrared sensor may further include an illuminated focus target in an image plane of the thermal-infrared sensor projected by the imaging optics onto the substrate. The focus target may indicate an axis of the substrate, as well as proper standoff distance.

It is thus a feature of at least one embodiment of the invention to allow for precise alignment of the detector to maximize the signal to noise ratio of the signal, as well as to simplify the process for the user of determining the precise target position monitored by the sensor.

The comparison circuit ensemble averages signals from the thermal-infrared sensor from multiple substrates to obtain the detection signal.

It is thus a feature of at least one embodiment of the invention of providing for a flexible trade-off between response speed and detection accuracy.

The detection signal may provide a comparison of the output of the thermal-infrared sensor to a threshold dependent on a temperature of the thermal-infrared sensor.

It is thus another feature of at least one embodiment of the invention to accommodate temperature sensitivity of inexpensive thermal-infrared detectors.

The detection signal provides a response time of less than 500 μs or a response time relative to a movement of the substrates such that less than ten substrates have passed before the detection signal with less than 5 mm positional error.

It is thus a feature of at least one embodiment of the invention to provide for real-time correction of glue gun timing errors in a timescale comparable to actual changes in the mechanism of the glue gun to allow high-speed operation without offsetting waste or manufacturing line downtime.

These particular objects and advantages may apply to only some embodiments falling within the claims and thus do not define the scope of the invention.

### BRIEF DESCRIPTION OF THE DRAWINGS

FIG. 1 is a schematic representation of a hot glue dispensing line showing a glue gun upstream from a thermal-infrared detector assembly of the present invention providing an error signal correcting a trigger signal used for triggering the glue gun;

FIG. 2 is a detailed block diagram of the thermal-infrared detector assembly of FIG. 1 showing the reflective imaging optics, temperature controlled substrate, and comparison circuit used to detect a leading edge of a dispensed glue bead;

FIG. 3 is an imaging plane view of the detector assembly of FIG. 2 showing its aspect ratio and illuminated focus targets on either side of the detector;

FIG. 4 is a plan view of the substrate of FIG. 1 receiving the glue bead and showing the glue bead and projected focus targets used for alignment of the detector assembly;

FIG. 5 is a schematic diagram of the comparison circuit of FIG. 2 extracting a timing error signal;

FIG. 6 is a side elevation a view of a glue bead of FIG. 1 showing its division into position elements by encoder or timer signals, with the glue bead positioned in alignment over a histogram showing an ensemble average of detection signals for multiple substrates and multiple glue beads, the histogram being applied to a threshold to produce a detection signal, shown below the histogram, which may be compared to a timing signal, shown below the detection signal, to produce an error value.

### DETAILED DESCRIPTION OF THE PREFERRED EMBODIMENT

Referring now to FIG. 1, a hot glue dispensing assembly line 10 may include a conveyor belt 12 or the like moving substrates 14, such as products to be assembled, in a direction 16 as carried regularly by the conveyor belt 12. Conveyor belt 12 may be attached to an encoder 18 providing a displacement signal 20 indicating the absolute location of the substrates 14 along the line of the conveyor belt 12.

A glue gun 24 may be positioned at an upstream end 22 of the conveyor belt 12, the glue gun 24 having a pressurized hot glue reservoir 26 connected to a nozzle 28 by means of electrically actuated valve 30. The valve 30 may receive a trigger signal 32 to open the valve to cause a dispensing of glue through the nozzle 28 in a glue bead 34 on to substrate 14. As is understood in the art, the speed of response of the valve 30 will change, being dependent on the characteristics of the glue, including its viscosity and chemical formulation, as well as wear and heating of the valve 30.

An industrial controller 35 or the like, may provide a timing signal 33, which is received by a timing signal shifter 36 which may advance or retard the timing signal 33 to correct the trigger signal 32 and hence the position of the glue bead 34. Advance and retard of the timing signal 33 may be readily accomplished within the regular periodicity of the timing signal through a phase locked loop or the like, or may be accomplished within the industrial controller 35 itself by varying delays based on signals precedent to the timing signal 33. The industrial controller 35 may also actuate glue gun 24 through an actuation signal 38 for example controlling the glue pump and glue heaters (not shown).

A thermal-infrared detector assembly 40 (e.g. having a detector sensitivity around 3.5 microns) may be positioned downstream from the glue gun 24 to detect substrates 14′ having had a glue bead 34 applied to their top surface. The detector assembly 40 is located at a known displacement from the nozzle 28 or a known time delay (for known speed of conveyor belt 12) from the nozzle 28. The detector assembly may receive infrared radiation from the glue bead 34 while the glue bead 34 is still at an elevated temperature, for example, before adhesion to a second component to be attached to the substrate 14′, so that the glue bead 34 may be readily distinguished from the substrate 14 by temperature alone without the need for dyes or other techniques.

The detector assembly 40 produces an error signal 42 that is received by timing signal shifter 36 and which indicates whether the glue bead 34 has been shifted to the right or to the left with respect to the substrate 14′ caused by advance or delay in the operation of valve 30 of the glue gun 24. This error signal 42 may be deduced by detecting, for example, the leading edge of the glue bead 34 and comparing it to a reference signal 44. The reference signal 44 may in a first embodiment be the signal from the encoder 18 at the time when the substrate 14′ was beneath the glue gun 24 and the trigger signal 32 occurred, summed with the offset between the nozzle 28 and the detector assembly 40. Alternatively reference signal 44 may be a time signal equal to the time when the substrate 14′ was positioned beneath the glue gun 24 and the trigger signal 32 occurred, summed to a time delay between the time substrate 14′ was beneath the glue gun nozzle 28 and the time when the substrate 14 arrived beneath the detector assembly 40.

The error signal (advance or delay) for turning on the glue gun (correlated to the rising edge of the infrared signature), and the error signal for turning off the glue gun (correlated to the falling edge of the infrared signature) may or may not be the same, as changes in glue gun turn on and turn off delays may or may not track each other perfectly. It will be understood that the present invention may also be used for separately correcting the turn off time of the glue gun using a similar procedure.

Critical to the feedback control of the valve 30 of the glue gun 24 is that a spatially accurate detector signal can be produced to effect corrections to the trigger signal 32 as the next substrate 14 is being glued or as a practical matter before five substrates have passed. The present invention provides a detector signal having a response time of greater than 2 kHz with a better than 5 mm positional accuracy.

It should be understood that a detector assembly having slower response speed and/or lesser positional accuracy can still be used for quality control purposes even though it is impractical for closed loop control. For example, if it is desired to determine the length of the glue bead 34 only, then an arbitrary and/or variable delay in the response time of detector assembly is of no concern. Further, if it is intended only to track long-term trends in the shifting of the glue bead 34 then high-speed detection is not required and positional accuracy can be improved by long averaging periods. Thus there is a trade-off between accuracy of detection and speed of detection and both are required for real-time corrective control.

Referring now to FIG. 2, the upper surface of the substrate 14 may pass along an image plane 46 intersecting the glue bead 34 and defined by a reflective optics 48 of the detector assembly 40 that receive infrared energy 50 from the substrate 14 and glue bead 34. This infrared energy 50 is focused on a second image plane 52 lying on the surface of a thermal-infrared detector 54. In the preferred embodiment the detector 54 is a lead selenium (PbSe) photoconductive detector. Detectors 54 of this type are available from New England Photoconductor of Norton, Mass. or Judson Technologies of Montgomeryville, Pa. The detector may have a total active area of approximately 1 mm². Alternatively a photovoltaic PbSe detector may be used.

The detector 54 is held on a temperature controlled substrate 56, for example, being a Peltier device, that is held at a constant temperature by a local controller 58 receiving a temperature signal 60 from a temperature sensor and 62 in thermal communication with the detector 54.

The temperature signal 60 is also provided to a comparison circuit 64 whose use of this temperature signal will be described below. The comparison circuit 64 also receives a detector signal 66 from the detector 54.

An optical filter 68 may be positioned on the upper surface of the detector 54 to filter out light having a frequency outside of the desired infrared band being centered at approximately 3.5 μm in wavelength. The filter 68 may be a chip of germanium anti-reflection coated for the 3.5 μm range to reject frequencies in the visible and near infrared range.

The reflective optics 48 may be protected from the environment by an opaque housing (not shown) which admits the infrared energy 50 through a protective window 70 formed of a halogenated plastic so as to prevent absorption of the desired infrared bandwidth. A suitable material for this window 70 is PolyIR5 commercially available from Fresnel Technologies of Fort Worth, Tex. The use of halogenated plastic avoids the hydrogen-carbon bonds that are opaque at the desired thermal-infrared frequency. Non-carbon based plastics such as silicon based plastics may also be employed.

The sensor 54 is offset from the path of the infrared energy 50 to provide for maximum received radiation.

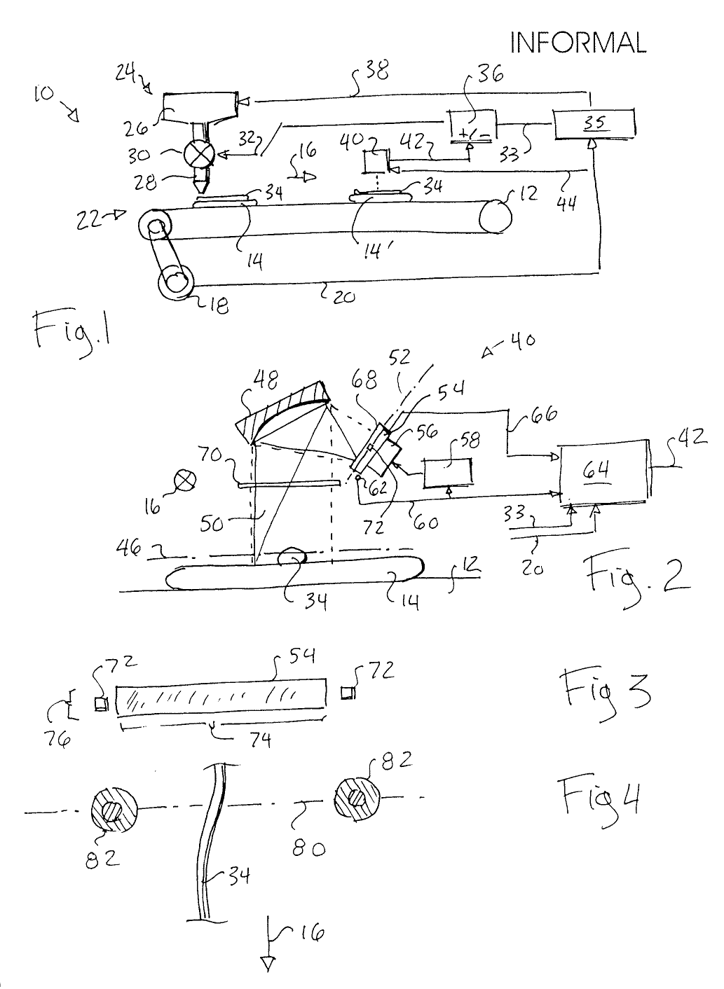

Referring now to FIGS. 2 and 3, small light-emitting diodes 72 may be positioned in the image plane 52 flanking the detector 54 along the detector's long dimension 74 (shown in FIG. 3). The shape of the detector 54 may be a rectangle, and the long dimension 74 may be three times to ten times longer than the shorter dimension 76. In use, the detector assembly 40 is arranged so that the long dimension 74 extends perpendicularly to the direction 16 of movement of the substrate 14. This long dimension 74 allows for accommodation of left and right shifting of the substrate 14 caused by movement of the conveyor belt 12 while minimizing the noise intrinsic to a thermal infrared detector, which increases with the area of the detector.

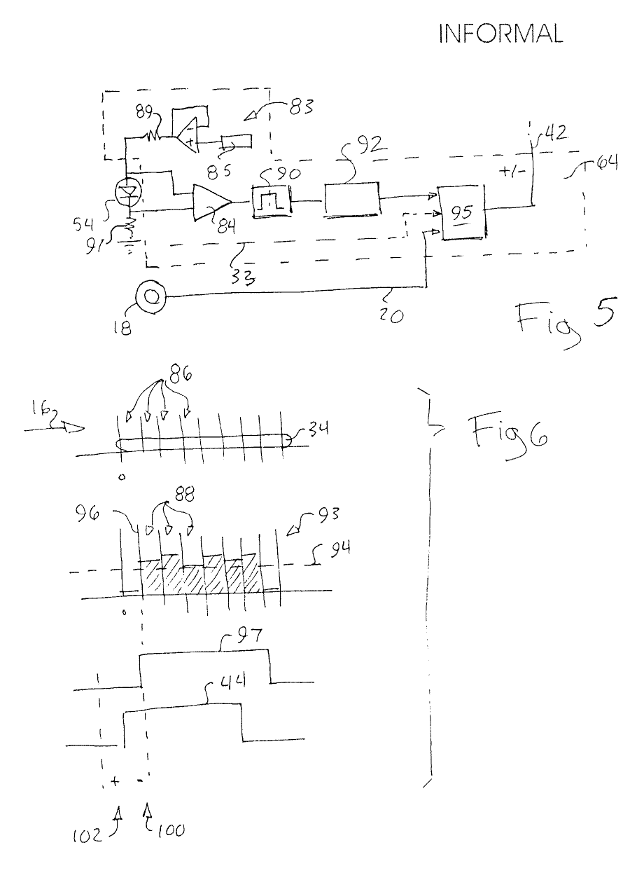

Referring to FIG. 2 and FIG. 4, the light-emitting diodes 72 may project light to the reflective optics 48 that is imaged on the image plane 46 to define an axis 80 between the images 82 of the light-emitting diodes 72 that allows proper orientation of the detector assembly 40. In addition, the size of the images 82 grows as the images 82 are out of focus allowing for proper focusing of the reflective optics 48 and for maximum rejection of noise illumination and maximum acceptance of infrared radiation from the glue beads 34.

Referring now to FIG. 5, the comparison circuit 64 may provide a signal to a driver circuit 83 applying a constant voltage to the detector 54 in series with equal resistors 89 and 91, the voltage determined by a voltage reference 85. A low noise, differential amplifier 84 may receive a voltage measurement across the detector 54 corresponding to changes in current of the detector 54 with changes in its resistance. The differential amplifier serves to reject EMI pickup, which can be a problem with a high impedance detector in an industrial environment. The output of this differential amplifier 84 may be received by electric band-pass filter 90. The filter 90 has a low blocking range intended to reduce flicker noise from the detector 54 (having 1/f frequency characteristics) and noise from environmental illumination at 120 Hz signals from fluorescent lights and the like and a high blocking range intended to reduce detector noise. The filter 90 may be a switched capacitor, finite impulse response, or other types of filters well-known in the art to provide passage of 4 kHz signals with minimum ringing.

The output from the filter 90 is provided to an ensemble averager 92 which may average readings from up to nine successive substrates 14 to obtain improved signal-to-noise discrimination.

Referring now to FIGS. 5 and 6, the ensemble averager 92 collects signals from the detector 54 as the detector reads infrared radiation from different segments 86 of the glue bead 34 partitioned according to the encoder signal or a time signal as described above. These signals are summed on a rolling average basis at different bins 88 of an internally collected histogram 93. Typically up to 1024 separate segments 86 and bins 88 will be used.

By averaging the signals only within each bin 88 over several substrates, random noise is decreased, without blurring the leading edge of the signal used to detect the beginning of the glue bead 34. The number of substrates 14 averaged controls the reduction of noise at the cost of decreasing the effective response speed of the detector assembly 40. Typically as few as five substrates 14 will be sampled.

The histogram 93 is compared against a threshold 94 to identify a start 96 of the glue bead 34 to extremely high precision on the order of one to 2 mm. The threshold 94 may be fixed or may be changed based on an empirical measurement of the change in the sensitivity of the detector 54 with temperature as deduced from the substrate temperature sensor 62. The result of this comparison is a threshold signal 97.

The threshold signal 97 may be compared to the reference signal 44 (as corrected by the inherent delay between the detection and the dispensing of the glue caused by their spatial separation) at error generator 95. When the leading edge of threshold signal 97 is after the leading edge of reference signal 44, a negative error 100 is measured while when the leading edge of threshold signal 97 comes before leading edge of reference signal 44 a positive error 102 is measured.

Referring again to FIG. 1, the measured error signal is provided to the timing signal shifter 36 to correct the trigger signal, with the positive error causing a retarding of the trigger signal 32 through the timing signal shifter 36 and a negative signal causing an advance of the trigger signal 32.

If desired, the histogram value for the present bin can be fed to a digital to analog converter as each electronic bin is 88 is revised when its corresponding position on the moving substrate 14 falls below the sensor. In so doing, a real-time signal can be provided to an oscilloscope, allowing the user to see a plot of the glue sensor reading signal levels. This may aid in diagnostics by allowing the user to determine if the proper threshold is being set, and by allowing the user to assess the signal to noise ratio for the chosen number of substrates averaged. This information could also be mapped onto a display (such as a liquid crystal dot matrix) on the side of the sensor.

It is specifically intended that the present invention not be limited to the embodiments and illustrations contained herein, but include modified forms of those embodiments including portions of the embodiments and combinations of elements of different embodiments as come within the scope of the following claims.

What we claim is:

1. A system for dispensing hot glue in a pattern on a substrate comprising:
a hot glue gun receiving a trigger signal at a trigger time to actuate a dispensing of glue on a substrate at a dispensing time;
a thermal-infrared sensor viewing a pattern of dispensed glue on the substrate by detecting a temperature difference between the substrate and the glue to produce a detection signal;
a comparison circuit receiving the detection signal to detect an error caused by variations between the trigger time and a dispensing time; and
a modification circuit modifying the trigger signal to reduce the detected error.

2. The system of claim 1 further including a transport mechanism moving the substrate with respect to the hot glue dispenser and the thermal-infrared sensor, the transport mechanism providing a displacement output;
wherein the comparison circuit receives the displacement output and detects error by comparing the displacement output at a time of the detection signal to a known displacement output at the trigger time modified by an offset in displacement between the hot glue dispenser and the thermal-infrared sensor.

3. The system of claim 1 further including a transport mechanism moving the substrate with respect to the hot glue dispenser and the thermal-infrared sensor, wherein the comparison circuit detects error by comparing a time of the detection signal to the trigger time modified by an offset in time between alignment of the substrate with the hot glue gun and the thermal-infrared sensor.

4. The system of claim 1 wherein the thermal-infrared sensor is a photoconductive sensor.

5. The system of claim 4 where the thermal-infrared sensor is a PbSe sensor.

6. The system of claim 1 wherein the thermal-infrared sensor has an aspect ratio of greater than three to one;

7. The system of claim 6 wherein a long dimension of the thermal-infrared sensor is positioned to image perpendicularly to motion of the substrate.

8. The system of claim 1 wherein the thermal-infrared sensor is operated with a constant voltage bias;

9. The system of claim 1 wherein the thermal-infrared sensor is mounted to a temperature controlled substrate.

10. The system of claim 1 wherein the thermal-infrared sensor includes a filter optically blocking light above and below a 3-μm wavelength.

11. The system of claim 1 wherein the thermal-infrared sensor is positioned behind a window of halogenated plastic;

12. The system of claim 1 wherein the thermal-infrared sensor receives an image of the substrate projected by reflective optics;

13. The system of claim 12 wherein the thermal-infrared sensor is offset from a path of light from the substrate to the reflective optics.

14. The system of claim 1 wherein the thermal-infrared sensor receives an image of the substrate projected by imaging optics and further including an illuminated focus target in an image plane of the thermal-infrared sensor and projected by the imaging optics onto the substrate.

15. The system of claim 14 where the focus target indicates an axis of the substrate.

16. The system of claim 1 wherein the comparison circuit ensemble averages signals from the thermal-infrared sensor from multiple substrates to obtain the detection signal.

17. The system of claim 1 wherein the detection signal provides a comparison of an output of the thermal-infrared sensor to a threshold dependent on a temperature of the thermal-infrared sensor.

18. The system of claim 1 where in the detection signal provides a response time of less than 500 μs with less than 5 mm positional error.

19. The system of claim 1 further including a transport mechanism moving the substrate with respect to the hot glue dispenser and the thermal-infrared sensor, wherein the detection signal provides a response time relative to a movement of the substrate such that less than ten substrates have passed before the detection signal is obtained.

20. A method for dispensing hot glue in a pattern on a substrate comprising:
(a) activating a hot glue gun at a trigger time to dispense glue on a substrate at a dispensing time;
(b) detecting a pattern of dispensed glue on the substrate by thermal-infrared imaging of a temperature difference between the substrate and the glue;
(c) monitoring the detection signal to detect an error caused by variations between the trigger time and a dispensing time of the glue gun; and
(d) modifying the trigger signal based on the monitoring to reduce the detected error.
